(19) United States
(12) Patent Application Publication
(10) Pub. No.: US 2008/0214194 A1
(43) Pub. Date: Sep. 4, 2008

(54) RADIO NETWORK CONTROLLER AND TRANSPORT NETWORK CONTROL METHOD FOR PERFORMING RELOCATION

(76) Inventor: Satoshi Noma, Tokyo (JP)

Correspondence Address: Jackson Chen;NEC Corporation of America, 6535 N. State Hwy 161, Irving, TX, 75039, US

(21) Appl. No.: 11/871,286

(22) Filed: Oct. 12, 2007

(30) Foreign Application Priority Data
Oct. 25, 2006 (JP) 2006-289783

(51) Int. Cl. H04Q 7/20

(52) U.S. Cl. 455/436

(57) ABSTRACT

Setting unit 103 stores a first call. When communication unit 101 receives a relocation request, management unit 104 generates a new call different from the first call, and new call information, and adds the new call information to the new call.

This application is based upon and claims the benefit of priority from Japanese patent application No. 2006-289783, filed on Oct. 25, 2006, the disclosure of which is incorporated herein in its entirety by reference.

### BACKGROUND OF THE INVENTION

1. Field of the Invention

The present invention relates to a radio network controller and a transport network control method.

2. Description of the Related Art

A communication system which uses transport network resources for communications is provided with a transport network resource utilizing apparatus for controlling transport network for its communications. A variety of transport network control methods are performed by the transport network resource utilizing apparatus.

For example, Document 1 (JP-2006-279630A) describes a transport network resource control system for controlling transport network by adding call information to a generated call for identifying a transport network resource for the call.

FIG. 1 is an explanatory diagram for describing the operation of the transport network resource control system described in Document 1.

In FIG. 1, transport network resource utilizing apparatus (hereinafter called “utilizing apparatus”) 601, upon receipt of a connection request for connecting to an external device, sets a transport network resource for connecting to the external device therethrough.

Specifically, transport network resource management unit (hereinafter called “management unit”) 602 first generates call 603 to the external device when the connection request is received. Subsequently, management unit 602 generates call information 604 for identifying a transport network resource for call 603, and adds call information 604 to call 603.

Utilizing apparatus 601 is equivalent to RNC (Radio Network Controller) in a radio network system.

In the following, the operation of RNC will be described in greater detail, giving a radio network system as an example.

FIG. 2 is a block diagram illustrating an exemplary radio network system.

In FIG. 2, the radio network system comprises CN (Core Network) 701, RNCs 711 and 712, and Node B (radio base station devices) 721 to 724.

RNCs 711 and 712 are connected to CN 701 and Node B 721 and 724, for example, through an ATM network.

Here, an interface for connecting CN 701 to RNCs 711 and 712 is called a lu interface. On the other hand, an interface for connecting between RNCs 711 and 712 is called a lur interface. Further, an interface for connecting RNCs 711 and 712 to Nodes B 721 to 724 is called an lub interface.

The call information includes interface call information for identifying each interface. The interface call information comprises lu call information for identifying a lu interface, lur call information for identifying a lur interface, and lub call information for identifying a lub interface.

As indicated by a dotted line in FIG. 2, CN 701 is connected to RNC 712 through the lu interface; RNC 712 is connected to RNC 711 through the lur interface; and Node B is connected to UE (user equipment). UE is not shown.

In this event, RNC 712 is called a serving RNC, while RNC 711 is called a drift RNC.

The serving RNC is an RNC which is directly connected to the lu interface. On the other hand, the drift RNC is an RNC which is not directly connected to the lu interface but is directly connected to the lur interface and lub interface.

While only one serving RNC exists for a predetermined UE, a plurality of drift RNCs may exist.

Upon receipt of a connection request, RNCs 711 and 712 each generate a call and call information for identifying a transport network resource for the call.

Specifically, RNC 711 generates a call, lur call information for identifying a lur interface for the call, and lub call information for identifying a tub interface for the call.

RNC 712 in turn generates a call, lu call information for identifying a lu interface for the call, and lur call information for identifying a lub interface for the call.

In the following, call information comprised of lur call information and lub call information is called call information for drift RNC, while call information comprised of lu call information and lur call information is called call information for serving RNC.

A movement of UE connected to Nodes B 721 to 724 may result in the switching of a transport network resource between CN 701 and Nodes B721 and 722.

FIG. 3 is a block diagram illustrating an exemplary radio network system in which a transport network resource is switched. In FIG. 3, the same components to those in FIG. 2 are designated the same reference numerals.

In FIG. 3, CN 701 is connected to RNC 711 through a lu interface, while RNC is connected to Nodes B 721 and 722 through a lub interface, as indicated by the dotted line.

When a transport network resource indicated by the dotted line in FIG. 2 is switched to a transport network resource indicated by the dotted line in FIG. 3, RNC 711 is switched from a drift RNC to a serving RNC. In FIG. 3, no drift RNC exists.

Such switching of transport network resources is called SRNS relocation (Serving Radio Network Subsystem Relocation). In the following, the SRNS relocation may simply be called the “relocation.”

Upon request for switching transport network resource, RNC 711 which operates a drift RNC changes a set call for drift RNC to a call for serving RNC and switches to a serving RNC.

FIG. 4 is an explanatory diagram for describing the operation of RNC 711 when the switching a transport network resource is requested. The following description is given of an example of the operation when the transport network resource indicated by the dotted line in FIG. 2 is switched to the transport network resource indicated by the dotted line in FIG. 3.

Management unit 711a of RNC 711 stores call 900 for a drift RNC. Call 900 includes lur call information 901 for identifying a lur interface, and lub call information 902 for identifying a lub interface.

When RNC 711 receives a relocation request for switching transport network resource and switches to serving RNC, management unit 711a first deletes lur call information 901. Subsequently, management unit 711a generates lu call information for identifying a lu interface for call 900, and adds lu call information 903 to call 900.

In this way, call 900 is switched from a call for a drift RNC to a call for a serving RNC, and RNC 711 is switched from drift RNC to serving RNC.

However, in such relocation control, since a call for a drift RNC is not independent of a call for a serving RNC, the control can encounter difficulties.

For example, when communication fails after lur call information has been deleted, it is difficult for RNC 711 to generate the same lur call information as the deleted lur call information and return to a drift RNC. The failure may be, for example, an interruption of communications between UE and Nodes B 721 and 722.

### SUMMARY OF THE INVENTION

It is an object of the present invention to provide a transport network resource utilizing apparatus and a transport network control method which are capable of increasing the independency of calls and performing relocations.

To achieve the above object, a transport network resource utilizing apparatus of the present invention includes storing means, receiving means, and managing means.

The storing means stores a first call including first call information for identifying a transport network resource.

The receiving means receives a relocation request for switching the transport network resource.

The managing means generates a second call separate from the first call when the receiving means receives the relocation request, and adds second call information for identifying the switched transport network resource to the second call.

Also, a transport network control method of the present invention is a transport network control method performed by a transport network resource utilizing apparatus including storing means for storing a first call including first call information for identifying a transport network resource.

The transport network control method comprise; receiving a relocation request for switching the transport network resource; generating a second call separate from the first call when the relocation request is received; and adding second call information for identifying the switched transport network resource to the second call.

According to the inventions described above, the second call is generated separate from the first call, and the second call information is added to the second call. It is therefore possible, for example, to increase the independency of calls and perform the relocation.

Also, a transport network resource utilizing apparatus of the present invention includes a C-plane device that has the functions of a C-plane, and a T-plane device that has the functions of T-plane. The C-plane device includes receiving means and C-plane managing means, while the T-plane device includes storing means, connecting means, and T-plane managing means.

The receiving means receives a relocation request for switching the transport network resource.

The C-plane managing means transmits the relocation request received by the receiving means to the T-plane device.

The storing means stores a first call including first call information for identifying the transport network resource.

The connecting means receives the relocation request from the C-plane device.

The T-plane managing means generates a second call separate from the first call when the receiving means receives the relocation request, and adds second call information for identifying the switched transport network resource to the second call.

Also, a transport network control method of the present invention is a transport network control method performed by a transport network resource utilizing apparatus including a C-plane device that has the functions of a C-plane, and a T-plane device including storing means for storing a first call including first call information for identifying a transport network resource for a communication and that has the functions of a T-plane, and includes an accepting step, a transmitting step, a connecting step, a generating step, and an adding step.

In the accepting step, the C-plane device accepts to transmit a relocation request for switching the transport network resource.

In the transmitting step, the C-plane device transmits the received relocation request to the T-plane device.

In the connecting step, the T-plane device receives the relocation request from the C-plane device.

In the generating step, the T-plane device generates a second call separate form the first call upon receipt of the relocation request.

In the adding step, the T-plane device adds second call information for identifying the switched transport network resource to the second call.

According to the inventions described above, when the C-plane device receives a relocation request, the T-plane device generates a second call separate from a first call, and adds second call information to the second call. It is therefore possible, for example, to increase the independency of calls and perform relocation even if the transport network resource utilizing apparatus is divided into a C-plane device and a T-plane device.

The above and other objects, features, and advantages of the present invention will become apparent from the following description with reference to the accompanying drawings which illustrate examples of the present invention.

### BRIEF DESCRIPTION OF THE DRAWINGS

FIG. 1 is an explanatory diagram for describing the operation of a transport network resource utilizing apparatus in Document 1;

FIG. 2 is a block diagram illustrating an exemplary radio network system which consists of serving RNC and drift RNC;

FIG. 3 is a block diagram illustrating an exemplary radio network system which consists of serving RNC, in which a transport network resource is switched to another transport network resource;

FIG. 4 is an explanatory diagram for describing the operation of RNC when relocation is requested in Document 1;

FIG. 5 is a block diagram illustrating the configuration of a transport network resource utilizing apparatus according to one exemplary embodiment of the present invention;

FIG. 6 is an explanatory diagram for describing an example of relocation processing

FIG. 7 is a flow chart for describing an example of the operation of the transport network resource utilizing apparatus;

FIG. 8 is a block diagram illustrating the configuration of a transport network resource utilizing apparatus according to another exemplary embodiment of the present invention; and

FIG. 9 is a flow chart for describing another example of the operation of the transport network resource utilizing apparatus.

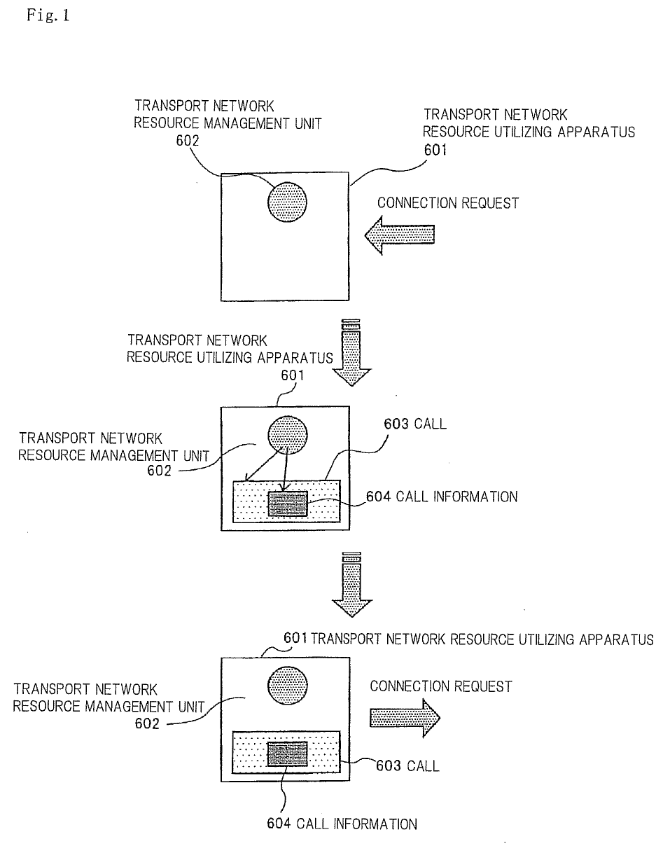

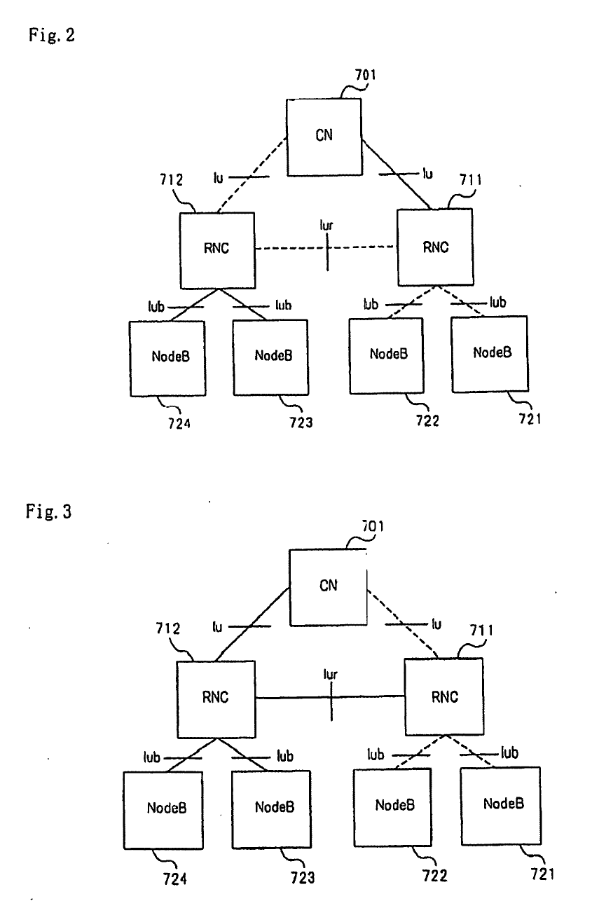

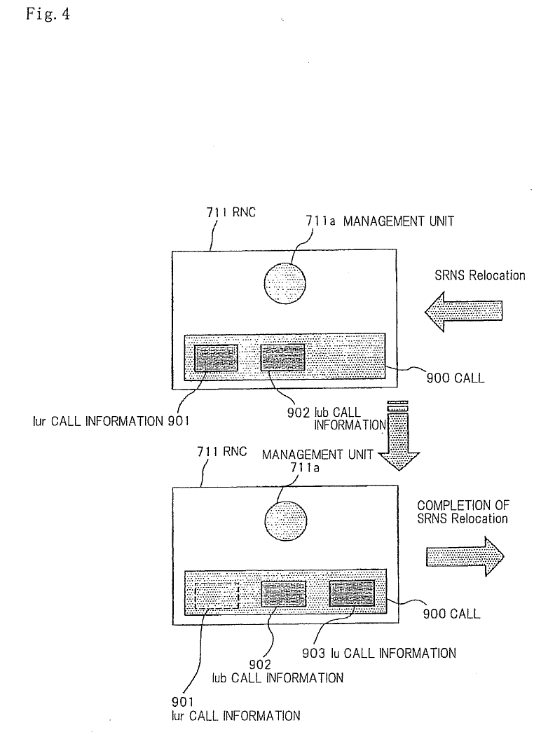

### DETAILED DESCRIPTION OF EXEMPLARY EMBODIMENT(S)

In the following, exemplary embodiments of the present invention will be described with reference to the drawings.

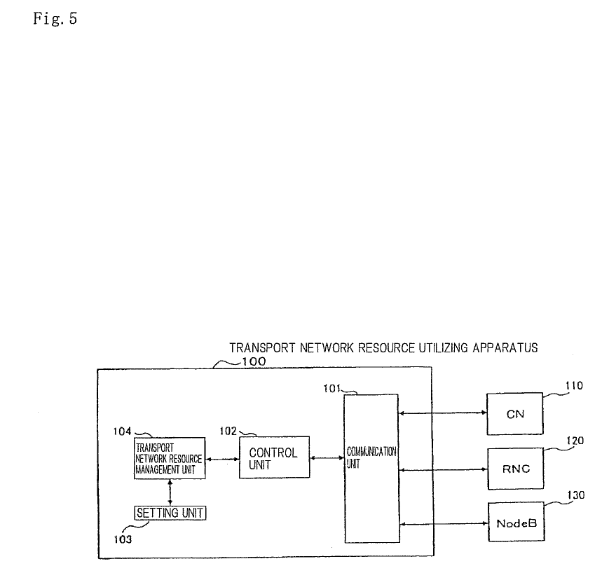

FIG. 5 is a block diagram illustrating the configuration of a transport network resource utilizing apparatus according to one exemplary embodiment of the present invention.

In FIG. 5, transport network resource utilizing apparatus 100 comprises communication unit 101, control unit 102, setting unit 103, and transport network resource management unit 104. In this embodiment, transport network resource utilizing apparatus 100 operates as a drift RNC. Also, transport network resource utilizing apparatus 100 is connected to CN 110, RNC 120, and to Node B 130.

CN 110 comprises GGSN (gateway GPRS support node) and SGSN (serving GPRS support node). GGSN and SGSN is not shown.

RNC 120 operates as a serving RNC. Node B 130 is connected to UE (not shown) through radio communications.

Communication unit 101 is an example of a receive device.

Communication unit 101 receives a relocation request from CN 110. The relocation request is information which indicates that a transport network resource is switched. The relocation request is, for example, an SRNS relocation request message.

Control unit 102 controls communications and transport network resources between CN 110, RNC 120, and Node B 130.

Control unit 102 also senses failures in radio communications through which Node B 130 and UE are connected.

For example, when a connection is interrupted between Node B 130 and UE, Node B 130 notifies communication unit 101 of transport network resource utilizing apparatus 100 of interruption information indicating that a connection to the UE is interrupted. When communication unit 101 receives the interruption information, control unit 102 senses a failure.

Also, when transport network resource management unit (hereinafter called “management unit”) 104 completes the relocation, control unit 102 transmits a completion message to CN 100 to indicate completion of the relocation.

Setting unit 103 stores a call for a drift RNC. The call for a drift RNC includes call information for the drift RNC for identifying a transport network resource for this call. The call information for a drift RNC comprises lur call information for identifying a lur interface, and lub call information for identifying a lub interface. The call for a drift RNC is an example of a first call, and the call information for a drift RNC is an example of first call information.

When communication unit 101 receives a relocation request, management unit 104 performs relocation.

Specifically, management unit 104 first generates a new call that is different from the call for a drift RNC. Subsequently, management unit 104 adds new call information for identifying a transport network resource that has been switched to the new call that is to generate a call for a serving RNC. Subsequently, management unit 104 deletes the call for a drift RNC stored in setting unit 103.

In this event, when control unit 102 senses a failure from the time when communication unit 101 receives the relocation request to the time when the new call information is added to the new call, management unit 104 aborts the relocation and deletes the new call.

The new call information is call information for a serving RNC which comprises lu call information for identifying a lu interface, and lub call information.

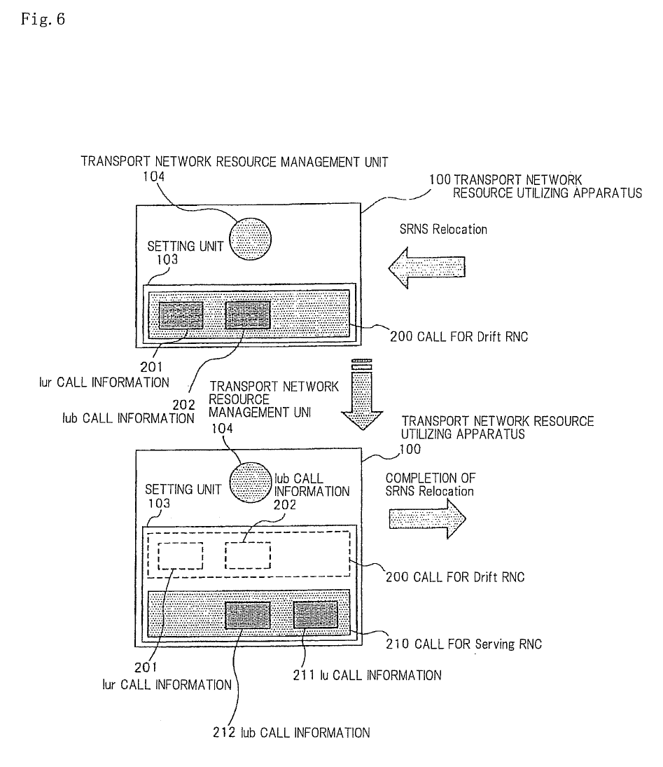

FIG. 6 is an explanatory diagram for describing an example of relocation processing. In FIG. 6, the same components to those in FIG. 5 are designated the same reference numerals. Also, FIG. 6 shows setting unit 103 and management unit 104 of transport network resource utilizing apparatus 100.

Before the relocation request is received, setting unit 103 stores call 200 for a drift RNC. Call 200 for a drift RNC includes lur call information 201 for identifying a lur interface, and lub call information 202 for identifying a lub interface.

When communication unit 101 receives a relocation request, management unit 104 generates new call 210, and stores new call 210 in setting unit 103.

Subsequently, management unit 104 confirms whether or not a failure is sensed in control unit 102.

When a failure is sensed, management unit 104 deletes new call 210.

On the other hand, when no failure is sensed, management unit 104 generates lu call information 211 for identifying a lu interface, and adds lu call information 211 to new call 210 stored in setting unit 103. After management unit 104 adds lu call information 211 to new call 210, then confirms whether or not a failure is sensed in control unit 102.

When a failure is sensed, management unit 104 deletes new call 210.

On the other hand, when no failure is sensed, management unit 104 adds lub call information to new call 210, and sets new call 210 for use by a serving RNC. Specifically, management unit 104 adds lub call information 212 to new call 210. And the lub call information 212 is equivalent to the lub call information 202 included in call 200 for a drift RNC.

Management unit 104 generates a call for a serving RNC in setting unit 103, and deletes the call for a drift RNC stored in setting unit 103 to complete the relocation.

Next, the operation will be described.

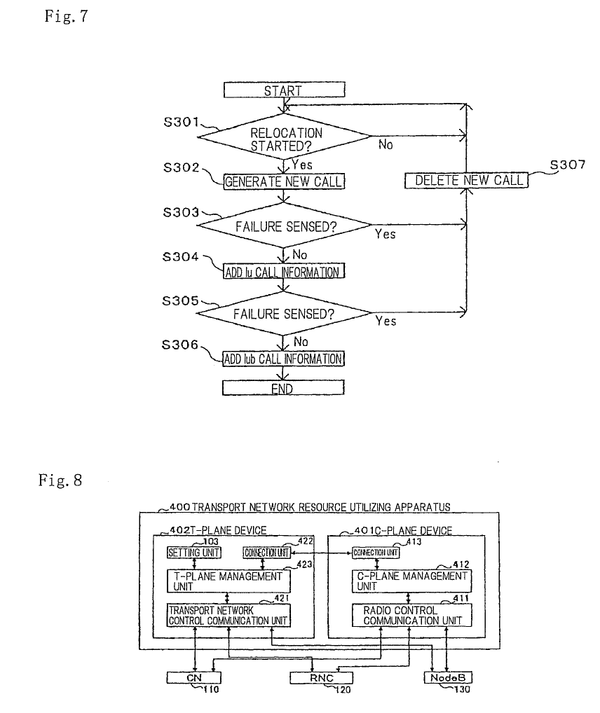

FIG. 7 is a flow chart for describing an example of the operation of transport network resource utilizing apparatus 100. Setting unit 103 stores a call for a drift RNC.

At step S301, management unit 104 confirms whether or not a relocation request is received from communication unit 101. Management unit 104 executes step S302 when it receives a relocation request, and executes step S301 when it receives no relocation request. Upon receipt of a relocation request from CN 110, communication unit 101 transmits the relocation request to management unit 104.

At step 302, management unit 104 generates a new call, and stores the new call in setting unit 103. Management unit 104 executes step S303 after finishing step S302.

At step S303, management unit 104 confirms whether or not a failure is sensed in control unit 102.

Specifically, when a failure is sensed, control unit 102 transmits a failure sensing signal to management unit 104. Management unit 104 confirms whether or not the failure sensing signal is accepted from control unit 102, and determines that a failure is sensed when the failure sensing signal is accepted, and determines that no failure is sensed when the failure sensing signal is not accepted.

Management unit 104 executes step S304 when no failure is sensed, and executes step S307 when a failure is sensed.

At step S304, management unit 104 generates lu call information, and adds the lu call information to the new call stored in setting unit 103. After finishing step S304, management unit 104 executes step S305.

At step S305, management unit 104 confirms whether or not a failure is sensed in control unit 103. Management unit 104 executes step S306 when no failure is sensed, and executes step S307 when a failure is sensed.

At step S306, management unit 104 adds lub call information included in the call for a drift RNC stored in setting unit 103 to the new call information stored in setting unit 103, and sets the new call for use by a serving RNC.

After generating the call for a serving RNC, management unit 104 deletes the call for a drift RNC stored in setting unit 103 to complete the relocation.

Upon completion of the relocation, control unit 104 generates a completion message, and transmits the completion message to control unit 102.

Upon receipt of the completion message, control unit 102 transmits the completion message to CN 110 through communication unit 101.

At step S307, management unit 104 deletes the new call stored in setting unit 103. After finishing step S307, management unit 104 executes step S301.

According to this exemplary embodiment, setting unit 103 stores a call including call information for a drift RNC. When communication unit 101 receives a relocation request, management unit 104 generates a new call different from that call, and adds new call information to the new call.

In this event, it is possible to increase the independency of calls and perform the relocation.

Also, in this exemplary embodiment, when control unit 102 senses a failure from the time when communication unit 101 receives the relocation request to the time when the new call information is added to the new call, the new call is deleted.

In this event, even if a failure occurs during relocation, it is possible to simply return to the original state.

Next, a description will be given of a transport network resource utilizing apparatus which includes a C-plane device and a T-plane device.

Functions of the RNC can be classified into a U-plane (User-Plane) for transferring user data; a C-plane (Control-Plane) for signaling to transfer control signals; and a T-plane (Transport-Plane) for controlling transport network resources.

In recent years, a separate control scheme has been provided, where a T-plane device that has the functions of the T-plane, a C-plane device that has the functions of the C-plane, and a U-plane device that has the functions of the U-plane are physically separated for control.

FIG. 8 is a block diagram illustrating an exemplary configuration of a transport network resource utilizing apparatus in which a C-plane device and a T-plane device are separated from each other. The U-plane device is not illustrated because it does not directly relate to the present invention.

The following description will be focused on components that are different from those described mainly in connection with FIG. 5. In FIG. 8, the same components as those in FIG. 5 are designated the same reference numerals.

In FIG. 8, transport network resource utilizing apparatus 400 comprises C-plane device 401 and T-plane device 402.

Assume that transport network resource utilizing apparatus 400 is operating as a drift RNC. Transport network resource utilizing apparatus 400 is connected to CN 110, RNC 120, and to Node B 130.

C-plane device 401 comprises radio communication control unit 411, C-plane management unit 412, and connection unit 413.

Radio control communication unit 411 transmits/receives radio control signals to/from CN 110, RNC, Node B 130, and to/from UE.

For example, radio control communication unit 411 receives a relocation request from CN 110, Since the transmission/reception of radio control signals other than the relocation request does not directly relate to the present invention, a description thereof is omitted.

When radio control communication unit 411 receives a relocation request, C-plane management unit 412 transmits the relocation request to T-plane device 402.

Also, C-plane management unit 412 senses a failure in a radio communication. For example, C-plane management unit 412 senses a failure when radio control communication unit 411 received interruption information.

Also, when connection unit 413 receives a completion message, C-plane management unit 412 transmits the completion message to CN 110.

Connection unit 413 is connected to T-plane device 402 to transmit/receive signals of T-plane device 402. For example, connection unit 413 receives a completion message from T-plane device 402.

T-plane device 402 comprises setting unit 103, transport network control communication unit 421, connection unit 422, and T-plane management unit 423.

Transport network control communication unit 421 transmits/receives transport network control signals to/from CN 110, RNC 120, and to/from Node B 130. Since the transmission/reception of the transport network control signals does not directly relate to the present invention, a description thereof is omitted.

Connection unit 422 receives a relocation request from connection unit 413 of C-plane device 401.

When connection unit 422 receives a relocation request, T-plane management unit 423 executes relocation processing. Since the relocation processing performed by T-plane management unit 423 is the same as the relocation processing performed by management unit 104, a description thereof is omitted.

Management unit 104 confirms whether or not a failure is sensed in control unit 102, whereas T-plane management unit 423 confirms whether or not a failure is sensed in C-plane management unit 412.

Specifically, when a failure is sensed, C-plane management unit 412 transmits a failure sensing signal to connection unit 422 through connection unit 413. Upon receipt of the failure sensing signal, connection unit 422 transmits the failure sensing signal to T-plane management unit 423. T-plane management unit confirms whether or not the failure sensing signal is accepted from connection unit 422, and determines that a failure is sensed when the failure sensing signal is accepted, and determines that no failure is sensed when the failure sensing signal is not accepted.

Upon completion of the relocation, T-plane management unit 423 generates a completion message. T-plane management unit 423 transmits the completion message to C-plane device 401 through connection unit 422.

Next, the operation will be described.

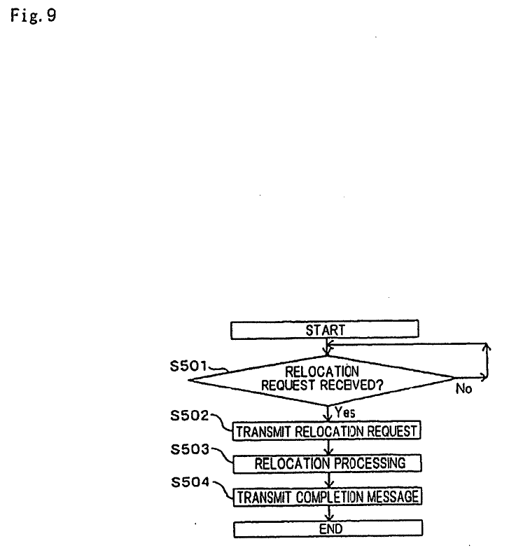

FIG. 9 is a flow chart for describing the operation of transport network resource utilizing apparatus 400.

At step S501, C-plane management unit 412 confirms whether or not a relocation request is received from radio control communication unit 411. C-plane management unit 412 executes step S502 when the relocation request is received, and executes step S501 when no relocation request is received.

Upon receipt of a relocation request from CN 110, radio control communication unit 411 transmits the relocation request to management unit 104.

At step S502, C-plane management unit 412 transmits the relocation request to connection unit 422 of T-plane device 402 through connection unit 413. Upon receipt of the relocation request, connection unit 422 transmits the relocation request to T-plane management unit 423. T-plane management unit 423 executes step S503 upon receipt of the relocation request.

At step S503, T-plane management unit 423 executes the relocation. Subsequently, upon completion of the relocation, T-plane management unit 423 executes step S504.

When a failure is sensed during the relocation, T-plane management unit 423 deletes a new call and enters a waiting state.

At step S504, T-plane management unit 423 generates a completion message, and transmits the completion message to connection unit 413 of C-plane device 401 through connection unit 422. Upon receipt of the completion message, connection unit 413 transmits the completion message to C-plane management unit 412.

Upon receipt of the completion message, C-plane management unit 412 transmits the completion message to CN 110 through radio control communication unit 411.

According to this exemplary embodiment, when radio control communication unit 411 of C-plane device 401 receives a relocation request, C-plane management unit 412 transmits the relocation request to T-plane device 402. When connection unit 422 of T-plane device 402 receives the relocation request, T-plane management unit 423 generates a new call different from a call stored in setting unit 103, and new call information for identifying a transport network resource for the new call, and adds the new call information to the new call.

In this event, even when the transport network resource utilizing apparatus is divided into a C-plane device and a T-plane device, it is possible to increase the independency of calls and to perform the relocation.

While preferred embodiments of the present invention have been described using specific terms, such description is for illustrative purposes only, and it is to be understood that changes and variations may be made without departing from the spirit or scope of the following claims.

In this embodiment, the transport network resource utilizing apparatus preferably includes sensing means connected to a radio base station device connected to a portable terminal through radio communication for sensing a failure in the radio communication, wherein the managing means deletes the second call when the sensing means senses a failure between the time when the receiving means receives the relocation request and the time when the second call information is added to the second call.

According to the embodiment described above, the second call is deleted when a failure is sensed between the time when the receiving means receives the relocation request and the time when the second call information is added to the second call.

Accordingly, even if a failure occurs during the relocation, it is possible to readily return to an original state.

Also, the first call information preferably includes lur call information for identifying a lur interface, and lub call information for identifying a lub interface, and the second call information includes lu call information for identifying a lu interface, and the lub call information.

What is claimed is:

1. A transport network resource utilizing apparatus comprising:
a storage device that stores a first call including first call information for identifying a transport network resource;
a receiving device that receives a relocation request for switching the transport network resource; and
a managing device that generates a second call separate from the first call when said receive device receives the relocation request, and adds second call information for identifying the switched transport network resource to the second call.

2. The transport network resource utilizing apparatus according to claim 1, connected to a radio base station device that is connected to a portable terminal through a radio communication,
further comprising a sensing device that senses a failure in the radio communications,
wherein said managing device deletes the second call when said sense device senses a failure between the time when said receive device receives the relocation request and the time when the second call information is added to the second call.

3. The transport network resource utilizing apparatus according to claim 1, wherein:
said first call information comprises lur call information for identifying a lur interface, and lub call information for identifying a lub interface, and
said second call information comprises lu call information for identifying a lu interface, and the lub call information.

4. A transport network resource utilizing apparatus including a C-plane device that has the functions of a C-plane, and a T-plane device that has the functions of T-plane, wherein:
said C-plane device includes:
receiving device that receive a relocation request for switching the transport network resource; and
C-plane manage device for transmitting the relocation request received by said receiving device to said T-plane device, and
said T-plane device includes:
storage device that store a first call including first call information for identifying the transport network resource;
connecting device that receive the relocation request from said C-plane device; and
T-plane managing device that generates a second call separate from than the first call when said receiving device receives the relocation request, and adding second call information, for identifying the switched transport network resource, to the second call.

5. A transport network resource utilizing apparatus comprising:
storing means for storing a first call including first call information for identifying a transport network resource;
receiving means for receiving a relocation request for switching the transport network resource; and
managing means for generating a second call separate from the first call when said receiving means receives the relocation request, and adding second call information for identifying the switched transport network resource to the second call.

6. A transport network control method performed by a transport network resource utilizing apparatus including a storage device that stores a first call including first call information for identifying a transport network resource, said method comprising:
receiving a relocation request for switching the transport network resource;
generating a second call separate from the first call when the relocation request is received; and
adding second call information for identifying the switched transport network resource to the second call.

7. The transport network control method according to claim 6, wherein:
said transport network resource utilizing apparatus is connected to a radio base station device that is connected to a portable terminal through radio communication, and
said method further comprises:
sensing a failure in the radio communication; and
deleting the second call when a failure is sensed between the time when the relocation request is received and the time when the second call information is added to the second call.

8. The transport network control method according to claim 6, wherein:
said first call information comprises lur call information for identifying a lur interface, and lub call information for identifying a lub interface; and
said second call information comprises lu call information for identifying a lu interface, and the lub call information.

9. A transport network control method performed by a transport network resource utilizing apparatus including a C-plane device that has the functions of a C-plane, and a T-plane device including a store device for storing a first call including first call information for identifying a transport network resource for a communication and that has the functions of a T-plane, said method comprising:
said C-plane device transmits a relocation request for switching the transport network resource;
said C-plane device transmits the received relocation request to said T-plane device;
said T-plane device receives the relocation request from said C-plane device;
said T-plane device generates a second call separate from the first call upon receipt of the relocation request; and
said T-plane device adds second call information, for identifying the switched transport network resource, to the second call.
